(19) United States
(12) Patent Application Publication
(10) Pub. No.: US 2009/0244234 A1
(43) Pub. Date: Oct. 1, 2009

(54) RECORDING APPARATUS AND RECORDING METHOD

(75) Inventors: Satoru SHIOHARA, Shiojiri-shi (JP); Hidemasa KANADA, Matsumoto-shi (JP); Yasushi YAJIMA, Minowa-machi (JP); Satoshi KANETA, Azumino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/411,601

(22) Filed: Mar. 26, 2009

(30) Foreign Application Priority Data
Apr. 1, 2008 (JP) 2008-095277
May 20, 2008 (JP) 2008-132169

(51) Int. Cl. B41J 2/01

(52) U.S. Cl. 347/102

(57) ABSTRACT

A recording apparatus is provided which includes: a recording unit that performs a recording operation on a target by causing liquid to adhere onto the target; a drying unit that performs a drying operation on the target on which the liquid is adhered by the recording operation of the recording unit in a state where a restricting force is not substantially applied thereto; and a restricting unit that performs a restricting operation on the target which has been subjected to the drying operation by the drying unit while supporting the target on a supporting face of a support member capable of supporting a surface of the target having the liquid adhered thereon in a uniform planar state, the restricting operation applying a restricting force to the target, the restricting force being directed toward the supporting face.

### BACKGROUND

1. Technical Field

The present invention relates to a recording apparatus and a recording method.

2. Related Art

As recording apparatuses which perform a recording operation by ejecting liquid (ink) onto a target, an ink jet printer (hereinafter, referred to as “printer”) is widely known. Such a printer performs printing (recording) by ejecting ink (liquid) supplied to a recording head (liquid jet head) from nozzles formed in the recording head to be adhered onto a top surface of a recording sheet as a target. That is, when the ink ejected from the respective nozzles is dried after being adhered onto the recording sheet, printing contents corresponding to the adhered patterns of the ink are displayed in colors.

When a recording sheet having moisture-permeable properties (liquid absorbing properties) is used as a target, rippling may occur in the recording sheet having ink absorbed therein. Such a phenomenon is referred to as a so-called cockling phenomenon. That is, when ink is ejected onto a recording sheet, the ink is absorbed in the recording sheet, whereby wood fibers (which are mainly composed of cellulose and will be referred to as “fibers”) which are the main components of the recording sheet, absorb moisture of the ink and are swollen. Moreover, when ink permeates into voids between the fibers of the recording sheet, hydrogen bonds between the fibers are cut.

As a result, because the fibers are put into a state of being freely movable in the recording sheet, the swollen fibers are moved while being pressed and squeezed together, so that the planar properties of the recording sheet are impaired. That is, in the recording sheet, an area (a liquid adhered area) on which the ink is adhered and recording is performed thereon experiences dilation deformation by the squeezing of the fibers, and thus the so-called rippling occurs.

Moreover, when the moisture is evaporated from the recording sheet in such a state where the rippling occurred therein, the swollen fibers shrink and recombination between the fibers at respective moved positions takes place. As a result, the rippling due to the dilation deformation is not disappeared and left on the dried recording sheet. Therefore, images formed on the recording sheet having such a rippling being left and fixed thereon are distorted, thereby lowering the printing precision (recording quality).

In order to cope with such a phenomenon, JP-B-3115657 discloses a technique of applying pressure to a recording sheet so as to reduce a dilation level thereof in the course of heating and drying the recording sheet in which rippling occurred due to the dilation deformation. That is, the top surface of the recording sheet having undergone the dilation deformation is pressed by means of a roller or a belt in a half-dried state where the recording sheet still contains moisture and fibers thereof are able to move, thereby restricting the recording sheet to be in a planar state. At the same time, the ink is dried by heating so that recombination between the fibers takes place.

However, in order to lower the dilation level of the rippling occurred in the recording sheet, it is necessary to restrict the recording sheet to be maintained in the planar state in a state where the hydrogen bonds between the fibers of the recording sheet are cut and the fibers are still allowed to move. Therefore, in the case of the printer disclosed in JP-B-3115657, the roller accompanying a pressing force therewith is brought into contact with the top surface of the recording sheet in the half-dried state where the ink is not yet completely dried.

However, when the pressing force of the roller is applied to such a recording sheet having formed therein a large rippling due to dilation deformation, which is not sufficiently heated and dried, the large rippling is twisted with movement of the recording sheet relative to the roller, thereby producing wrinkles.

### SUMMARY

An advantage of some aspects of the invention is that it provides a recording apparatus and a recording method capable of suppressing rippling or wrinkles on a target from being left and fixed thereon.

According to an aspect of the invention, there is provided a recording apparatus which includes: a recording unit that performs a recording operation on a target by causing liquid to adhere onto the target; a drying unit that performs a drying operation on the target on which the liquid is adhered by the recording operation of the recording unit in a state where a restricting force is not substantially applied thereto; and a restricting unit that performs a restricting operation on the target which has been subjected to the drying operation by the drying unit while supporting the target on a supporting face of a support member capable of supporting a surface of the target having the liquid adhered thereon in a uniform planar state, the restricting operation applying a restricting force to the target, the restricting force being directed toward the supporting face.

In general, the target can be classified into a target having liquid repellent properties, such as film, and a target having liquid absorbing properties, such as recording paper. When the recording operation is performed on the target having liquid absorbing properties by causing liquid (e.g., ink containing moisture and the like), which when absorbed in the target, can cause dilation deformation of the target, to be adhered onto the target, the liquid is absorbed in a liquid adhered area of the target to be subject to dilation deformation. Therefore, when the target is dried in such a state, rippling due to the dilation deformation is left on the target.

In this respect, according to such a configuration, since the drying unit performs the drying operation on the target, evaporation of the liquid adhered on the target is accelerated, thereby suppressing the liquid from being permeated and diffused into the target. That is, the dilation level of the area (hereinafter, referred to as “liquid adhered area”) of the target having the liquid adhered thereon is suppressed. Moreover, the target in which the evaporation of the liquid is accelerated and the amount of liquid permeated into the liquid adhered area is lowered is restricted by the restricting unit. Then, the liquid adhered area of which the dilation level is suppressed by the drying operation of the drying unit can be held in the uniform planar state without producing wrinkles thereon, unlike the case where it is restricted in a state of having a large dilation level. Moreover, when the liquid is evaporated from the liquid adhered area by natural seasoning while maintaining such a state, corresponding recording contents are fixed to the liquid adhered area while neither rippling nor wrinkles is produced on the target. Therefore, it is possible to suppress the rippling or wrinkles from being left and fixed on the target.

In accordance with another embodiment of the invention, the recording apparatus has such a configuration that the restricting force which is applied to the target in the drying operation is smaller than the restricting force which is applied to the target in the restricting operation.

In general, the liquid adhered area of the target, which has undergone dilation deformation by the liquid adhered thereto and absorbed therein, is likely to deform upon application of a strong restricting force thereto, because liquid is absorbed therein. Therefore, when a strong restricting force is applied to the liquid adhered area being in such a dilated and deformed state in the direction for lowering the dilation level thereof in order to accelerate the evaporation of the liquid therefrom, wrinkles may be produced on the liquid adhered area by being deformed upon receipt of the restricting force.

In this respect, according to such a configuration, by decreasing the restricting force which is applied to the target before the liquid is sufficiently evaporated by the drying operation, the target is allowed to be deformed, thereby suppressing the wrinkles from being left on the target.

In accordance with a further embodiment of the invention, the recording apparatus has such a configuration that the restricting force which is applied to the target in the drying operation is controlled so as not to cause forced deformation of the target having the liquid adhered thereon.

According to such a configuration, the target which is subjected to the drying operation is able to accelerate the evaporation of the liquid in a state where the dilation deformation thereof is not suppressed. Therefore, in the target on which the evaporation of the liquid by the drying operation is not yet performed sufficiently, a dilated portion thereof might not be twisted by the restricting force. Thus, it is possible to suppress the wrinkles from being produced in the drying operation.

In accordance with a still further embodiment of the invention, the recording apparatus has such a configuration that the restricting force which is applied to the target in the drying operation is less than 9.8 N per A4-size page.

According to such a configuration, the liquid adhered area having undergone the dilation deformation by the liquid absorbed therein is dried in a state in which a restricting force as small as approximately zero, e.g., less than 9.8 N per A4-size page is applied in the drying operation. Therefore, it might not lead to production of wrinkles which may be produced on the target deformed by the restricting force. Moreover, it is possible to accelerate the evaporation of the liquid so that the degree of dilation deformation is lowered.

In accordance with a still further embodiment of the invention, the recording apparatus has such a configuration that the restricting force which is applied to the target in the restricting operation is controlled so as to cause forced deformation of the target having the liquid adhered thereon.

Since the liquid adhered area having undergone the dilation deformation by absorbing the liquid therein is hardly deformed even upon receipt of the restricting force if the evaporation of the liquid is accelerated by the drying operation, it is difficult to achieve the uniform planar state with a small restricting force.

In this respect, according to such a configuration, the restricting force capable of forcibly deforming the target is applied to the liquid adhered area of which the dilation level is suppressed because the evaporation of the liquid is accelerated by the drying operation of the drying unit. Therefore, it is possible to allow the liquid adhered area having undergone the dilation deformation to be maintained in the uniform planar state even with such a restricting force.

In accordance with a still further embodiment of the invention, the recording apparatus has such a configuration that the restricting force which is applied to the target in the restricting operation is equal to or greater than 49 N per A4-size page.

According to such a configuration, the restricting force which is sufficiently large and is equal to or greater than 49 N per A4-size page is applied to the liquid adhered area of which the dilation level is suppressed because the evaporation of the liquid is accelerated by the drying operation of the drying unit. Therefore, it is possible to allow the liquid adhered area having undergone the dilation deformation to be maintained in the uniform planar state even with such a restricting force.

In accordance with a still further embodiment of the invention, the recording apparatus has such a configuration that the restricting unit performs the restricting operation on the target which is half dried by the drying operation.

According to such a configuration, since the restricting operation is performed on the target in a half-dried state where the liquid adhered on the target is not yet completely dried, it is possible to deform the target before its dilated and deformed shape is left and fixed thereon.

In accordance with a still further embodiment of the invention, the recording apparatus has such a configuration that the restricting unit performs the restricting operation on the target within three seconds after the drying unit performs the drying operation on the target.

According to such a configuration, the restricting force which holds the liquid adhered area in the uniform planar state can be applied to the liquid adhered area in which the evaporation of the liquid is accelerated by the drying operation of the drying unit, before the dilated and deformed shape is left and fixed on the liquid adhered area by natural seasoning after the end of the drying operation. That is, by controlling the time interval from the end of drying to the start of restriction to be within three seconds, the restricting force can be applied, at an appropriate timing, to the target which has absorbed liquid therein and is in the dilated and deformed state and which is easily deformed upon receipt of the restricting force.

In accordance with a still further embodiment of the invention, the recording apparatus has such a configuration that the restricting unit applies the restricting force to the target in the restricting operation for a period of one to five seconds.

According to such a configuration, the liquid adhered area of which the dilation level is suppressed because the evaporation of the liquid is accelerated by the drying operation of the drying unit can be continuously restricted to be in the uniform planar state until the movement of the liquid within the liquid adhered area is stabilized. That is, by continuously restricting the target for only a period of time necessary for fixing the shape of the liquid adhered area to a shape which corresponds to the uniform planar state, it is possible to suppress the liquid adhered area from again undergoing the dilation deformation after the application of the restricting force to the target is released. Therefore, compared with a case where the target is restricted for a long period of time (longer than 5 seconds) until the liquid is completely evaporated from the liquid adhered area, it is possible to improve the throughput of the recording apparatus.

In accordance with a still further embodiment of the invention, the recording apparatus has such a configuration that the restricting unit applies the restricting force to the target in such a manner that based on a restriction start position at which the restricting force is first applied to the target, a restricting force application range is sequentially extended from the restriction start position.

In general, when the restricting force is applied at once to the liquid adhered area of the target which are swollen and deformed by absorbing liquid therein, a local skewing may occur in the restricting force applied to the target depending the deformation level or the size of the liquid adhered area, thereby producing wrinkles thereon.

In this respect, according to such a configuration, the range of areas of the target which are applied with the restricting force to be restricted to the supporting face is sequentially extended. Therefore, since the liquid adhered area is sequentially restricted to the supporting face from a portion thereof corresponding to the restriction start position or a position located close to the restriction start position, the target can be smoothly restricted. Accordingly, it is possible to suppress production of the wrinkles which are caused by the skewing of the restricting force applied to the target.

According to another aspect of the invention, there is provided a recording method which includes the steps of: performing a recording operation on a target by causing liquid to adhere onto the target; performing a drying operation on the target which has been subjected to the recording operation in a state where a restricting force is not substantially applied thereto; and performing a restricting operation on the target which has been subjected to the drying operation, the restricting operation restricting the target with a restricting force capable of restricting a surface of the target having the liquid adhered thereon in a uniform planar state.

According to such a configuration, since the liquid adhered area of the target to which liquid is adhered in the recording step is able to accelerate the evaporation of the liquid by the drying operation in the step of performing the drying operation, the dilation level thereof is suppressed. Moreover, in the step of performing the restricting operation, the restricting force is applied to the target in which the liquid is evaporated to some degree from the liquid adhered area in the step of performing the drying operation so that the uniform planar state is achieved in the liquid adhered area, and the target is subject to natural seasoning in such a restricted state. Therefore, similar to the case of the above-described recording apparatus, it is not only possible to suppress the rippling or wrinkles from being left on the target, but also to suppress the recording quality from being lowered.

### BRIEF DESCRIPTION OF THE DRAWINGS

The invention will be described with reference to the accompanying drawings, wherein like numbers reference like elements.

FIG. 1 is a schematic view of a printer according to a first embodiment of the invention.

FIG. 2 is a plan view illustrating the overlapping relationship between sheet, a transport belt, and a support platen.

FIG. 3 is a schematic view of a restricting force measurement device.

FIG. 4 is an explanatory view for explaining the relationship between a restricting force and a restriction period in a restricting zone.

FIG. 5 is an explanatory view for explaining a brief summary of a cockling judgment test.

FIG. 6 is a schematic sectional view of a support platen according to a second embodiment of the invention.

### DESCRIPTION OF EXEMPLARY EMBODIMENTS

### First Embodiment

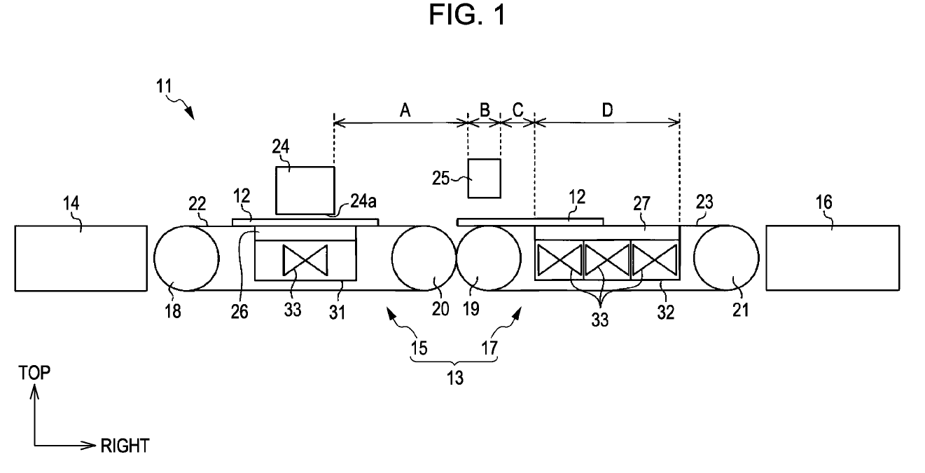

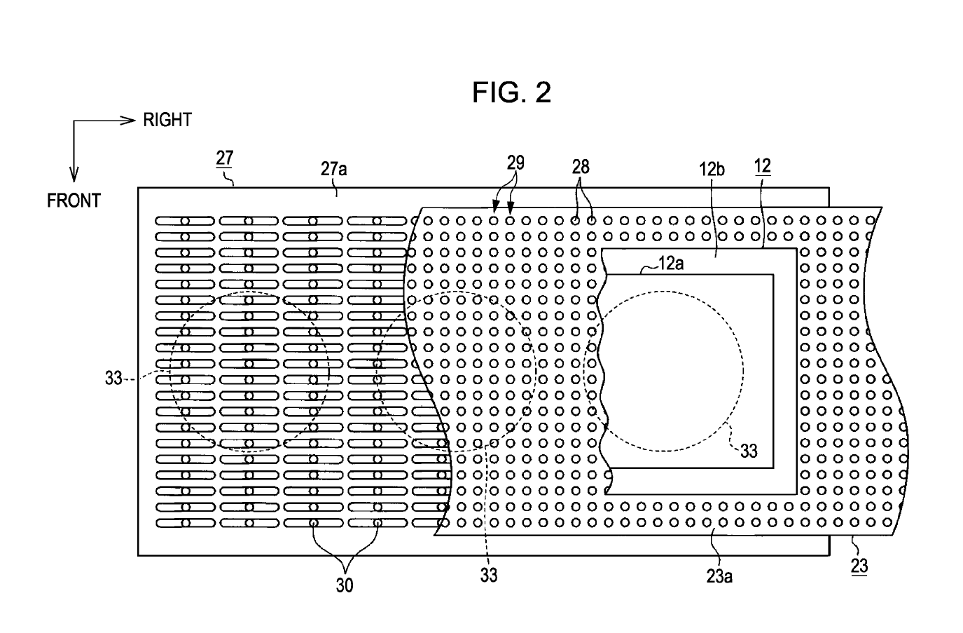

Hereinafter, a first embodiment of the invention will be described with reference to the accompanying drawings, in which a recording apparatus and a recording method according to the invention is embodied in an ink jet printer. In the following description, “up-down direction,” “front-rear direction,” and “left-right direction” are defined based on the directions indicated by the arrows in FIGS. 1 and 2.

As illustrated in FIG. 1, an ink jet printer (hereinafter, referred to as “printer”) as the recording apparatus is provided with a transport mechanism 13 as a transport unit for transporting a sheet 12 as the target. The transport mechanism 13 is configured to include a first transport portion 15 that transports the sheet 12 fed from a sheet feeding tray 14, which is disposed on the upstream side (left side) in the transport direction, to the downstream side (right side) and a second transport portion 17 that transports the sheet 12 transported by the first transport portion 15 further toward the downstream side to be discharged to a discharge tray 16.

The transport portions 15 and 17, respectively, have a first drive pulley 18 and a second drive pulley 19 which are rotated by driving force of non-illustrated motors, respectively, and have mutually parallel axial lines, and a first driven pulley 20 and a second driven pulley 21 which are configured to be rotatable about an axial line which is parallel to the axial lines of the drive pulleys 18 and 19. Further, a first endless transport belt 22 is stretched between the first drive pulley 18 and the first driven pulley 20, and a second endless transport belt 23 serving as the support member is stretched between the second drive pulley 19 and the second driven pulley 21. The transport belts 22 and 23 perform a revolving motion with rotation of the corresponding drive pulleys 18 and 19, whereby the sheet 12 fed from the sheet feeding tray 14 is transported from the first transport portion 15 to the second transport portion 17 in a state of being mounted on the first transport belt 22 and is then further transported toward the discharge tray 16 in a state of being mounted on the second transport belt 23.

As illustrated in FIG. 1, a recording head 24 as the recording unit that ejects ink as the liquid toward a top surface of the sheet 12 being transported in a state of being mounted on the first transport belt 22 is arranged at a position of the first transport portion 15 located above the first transport belt 22. From this recording head 24, ink containing moisture such as dye ink is ejected, and the ink is adhered onto the top surface of the sheet 12, whereby a recorded area 12a (see FIG. 2) as the liquid adhered area is formed on the top surface of the sheet 12.

That is, on a nozzle forming surface 24a which is defined in a lower surface of the recording head 24, a plurality of nozzle arrays (not illustrated), which extends along a width direction (front-rear direction) of the sheet 12, is arranged at regular intervals in the transport direction (left-right direction). The recording head 24 is configured to eject ink over an entire width of the sheet 12 in synchronism with movement of the sheet 12 passing below the recording head 24 so that printing (recording operation) is performed on the sheet 12. In this respect, the recording head 24 of the present embodiment can be said to be a so-called full line-type line head which has an overall shape corresponding to the entire width of the sheet 12 in a direction perpendicular to the transport direction of the sheet 12.

Moreover, a heater 25 as the drying unit capable of heating to accelerate drying of the sheet 12 conveyed from the first transport belt 22 to the second transport belt 23 is arranged at a position of an extreme upstream end of the second transport portion 17 located above the second transport belt 23. This heater 25 is an infrared heater that radiates infrared rays to the sheet 12, and is configured to heat the recorded area 12a of the sheet 12 on which the ink ejected from the recording head 24 is adhered to be permeated therein in a non-contacting manner with an ink adhering surface (the top surface) of the sheet 12.

Furthermore, in the transport portions 15 and 17, a first support platen 26 and a second support platen 27 having planar upper surfaces, respectively, are arranged between the first drive pulley 18 and the first driven pulley 20 and between the second driven pulley 21 and the second drive pulley 19, respectively. When the transport belts 22 and 23 perform the revolving motion, back surfaces of the portions of the transport belts 22 and 23 on which the sheet 12 is mounted to be transported to the downstream side (from left to right) are brought into sliding contact with upper surfaces of the corresponding support platens 26 and 27.

Moreover, in the transport portions 15 and 17, a plurality of holes is formed in the transport belts 22 and 23 and the support platens 26 and 27, respectively. Because the forming patterns of these respective holes are the same in both transport portions 15 and 17, the forming patterns of the respective holes formed in the second transport belt 23 and the second support platen 27 of the second transport portion 17 will be described with reference to FIG. 2.

As illustrated in FIG. 2, the second transport belt 23 is configured so that a top surface thereof functions as a supporting face 23a for supporting the sheet 12. Moreover, a number of air holes 28 are formed in the second transport belt 23 so as to pass through the top surface serving as the supporting face 23a and the back surface making sliding contact with the second support platen 27. Further, these air holes 28 are regularly arranged so that a plurality of air hole arrays 29 which extends along the front-rear direction is formed at predetermined intervals in the left-right direction. The air holes 28 and the air hole arrays 29 are also formed in the first transport belt 22 of the first transport portion 15.

Moreover, a number of suction holes 30 are formed in the second support platen 27 so as to pass through the second support platen 27 in the up-down direction (the thickness direction of the second support platen 27). The respective suction holes 30 are formed at positions corresponding to the positions in the front-rear direction of the respective air holes 28 of the second transport belt 23 while being formed at positions spaced at larger intervals (e.g., about three times) than the respective air holes 28 in the left-right direction so as to pass through the upper surface 27a and the lower surface of the second support platen 27. Further, the openings of the suction holes 30 on the upper surface 27a have an elongated groove shape extending along the left-right direction. The respective suction holes 30 are also formed in the first support platen 26 of the first transport portion 15.

As illustrated in FIGS. 1 and 2, on the lower side of the first support platen 26, a first box-shaped suction portion 31 for sucking the insides of the respective suction holes 30 is provided so as to cover the openings of the respective suction holes 30 on the lower surface side of the first support platen 26. On the other hand, on the lower side of the second support platen 27, a second box-shaped suction portion 32 for sucking the insides of the respective suction holes 30 is provided so as to cover the openings of the respective suction holes 30 on the lower surface side of the second support platen 27.

Among them, one fan 33 is installed in the first suction portion 31. On the other hand, three fans 33 are installed in the second suction portion 32 so as to individually correspond to non-illustrated three suction chambers that are partitioned. The insides of the suction holes 30 are sucked with the driving of the respective fans 33 and are set to negative pressure, whereby a downward suction force (restricting force) is applied to the sheet 12 in the state of being mounted on the transport belts 22 and 23 through the air holes 28 communicated via the elongated groove-shaped openings of the suction holes 30.

In addition, as illustrated in FIG. 1, in a transport path along which the sheet 12 is transported by the transport belts 22 and 23 of the transport mechanism 13, a plurality of zones is sequentially defined on the downstream side of a recording zone opposing the recording head 24. First, on the downstream side of the recording zone, a first transport zone A in which the sheet 12 having the ink adhered on the recorded area 12a by the ink ejected from the recording head 24 is transported to an arrangement position of the heater 25 is defined to be continuous with the recording zone. Moreover, on the downstream side of the first transport zone A, a heating zone B in which the heater 25 capable of heating the sheet 12 is provided is defined to be continuous with the first transport zone A.

Further, on the downstream side of the heating zone B, a second transport zone C in which the sheet 12 in which evaporation of the ink from the recorded area 12a is accelerated by the heating in the heating zone B is transported to be mounted on the second support platen 27 is defined to be continuous with the heating zone B. Furthermore, on the downstream side of the second transport zone C, a restricting zone D in which the sheet 12 is restricted to be maintained in a planar state on the second support platen 27 is defined to be continuous with the second transport zone C.

Next, a suction force measurement method for defining the magnitude of a suction force (restricting force) F1 which is applied to the sheet 12 by each of the suction portions 31 and 32 with the driving of the fans 33. In the present embodiment, it will be assumed that 1 kgf≈9.8 N.

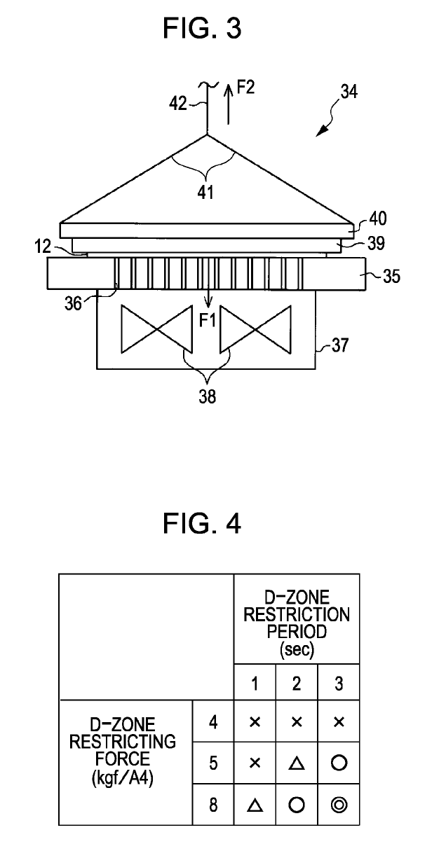

As illustrated in FIG. 3, a suction force (restricting force) measurement device 34 is provided with a support platen 35 similar to the support platens 26 and 27 of the transport portions 15 and 17, and a plurality of suction holes 36 is formed so as to pass through the support platen 35 in the thickness direction thereof. On the lower side of the support platen 35, a box-shaped suction portion 37 for sucking the insides of the respective suction holes 36 is provided so as to cover the openings of the respective suction holes 36 on the lower surface of the support platen 35, and two fans 38 are installed in the suction portion 37.

Moreover, the sheet 12 and a rectangular glass plate 40 which are integrated in a stacked form via a flexible shock-absorbing material 39 with the sheet 12 being disposed on the bottom side are mounted on an upper surface of the support platen 35, and base ends of four wires 41 are fixedly secured to four corners of the glass plate 40. Further, the distal ends of the respective wires 41 are connected to one main wire 42 which is above the central portion of the glass plate 40.

Therefore, when a tensile force F2 which is a upwardly pulling force is applied to the main wire 42, the vertically upward tensile force F2 is applied to the glass plate 40 via the respective wires 41, and the vertically upward tensile force F2 is also applied to the sheet 12 via the shock-absorbing material 39. On the other hand, when the respective fans 33 within the suction portion 37 are driven, since negative pressure is acting on the sheet 12 on the support platen 35 via the suction holes 36, the downward suction force F1 is applied to the sheet 12.

When the suction force is measured using such a suction force measurement device 34, the tensile force F2 applied to the main wire 42 is gradually increased in a state in which the downward suction force F1 is applied to the sheet 12 by driving the respective fans 38 of the suction portion 37. Then, the sheet 12 becomes distant from the upper surface of the support platen 35 at a time point when the tensile force F2 exceeds the suction force F1.

At this time, in a state where the suction force F1 is applied to the sheet 12 having the same dimension as A4 size paper (210×297 mm) or having the same area (e.g., 110×567 mm or 231×270 mm) as A4 size paper, for example, if the sheet 12 and the support platen 35 are separated from each other when the gradually increasing tensile force F2 becomes 29.4 N (3 kgf), the force that the sheet 12 receives at this moment by the driving of the fans 38 is defined as the restricting force of 29.4 N/A4 (3 kgf/A4).

That is, the restricting force represents the strength of the force per unit area that restricts the sheet 12 to be maintained in a surface contact state on the upper surface of the support platen 35. Therefore, if the sheet 12 and the support platen 35 are separated from each other when the suction force F1 is 98 N (10 kgf) and the tensile force F2 applied to the sheet 12 having the same size as A3 size paper (297×420 mm), for example, is 98 N (10 kgf), the restricting force at this time corresponds to 49 N/A4 (5 kgf/A4) when converted into A4 size.

Next, the operation of the printer 11 according to the present embodiment, having the above-described configuration will be described based on the operation when the sheet 12 is transported so as to sequentially pass the first transport zone A, the heating zone B, the second transport zone C, and the restricting zone D after printing is performed thereon by the recording head 24 in the recording zone.

When printing is performed on the sheet 12 in the printer 11, the sheet 12 is first fed from the sheet feeding tray 14 to be mounted on the first transport belt 22, and at the same time, the transport belts 22 and 23 start the revolving motion in order to transport the sheet 12 to the downstream side. Moreover, the insides of the suction holes 30 of the respective support platens 26 and 27 are sucked in response to driving of the fans 33 of the respective suction portions 31 and 32. Then, negative pressure is produced in the air holes 28 disposed in areas of the first transport belt 22 having the sheet 12 mounted thereon and the suction holes 30 of the support platen 26 being communicated with the air holes 28 via the elongated groove-shaped openings. Therefore, the sheet 12 mounted on the first transport belt 22 is transported to the downstream side in a restricted state where it is supported in a planar shape on the first transport belt 22 due to the negative pressure, and ink is adhered onto the recorded area 12a by the ink ejection from the recording head 24 in the recording zone (recording step).

Subsequently, in the first transport zone A, the sheet 12 is transported to the downstream side in a state where it is neither heated nor restricted. Therefore, the ink adhered onto the recorded area 12a of the sheet 12 is permeated and diffused into the sheet 12 in the course of transportation, thereby dilating and deforming the recorded area 12a. The recorded area 12a of the sheet 12 in the present embodiment is defined in a rectangular area in which ink is adhered in a beta form, and the perimeter of this area is surrounded by a non-recorded area (non-liquid adhered area) 12b on which no ink is adhered. The non-recorded area 12b refers to an area in which combinations between fibers (constituent materials) of the sheet 12 are maintained, because ink is neither adhered on a top surface thereof nor ink is permeated therein.

Here, the sheet 12 of the present embodiment is a porous material having liquid absorbing properties in which pulp fibers made from wood (which are mainly composed of cellulose and will be referred to as “fibers”) are stacked to form a net-like structure. Therefore, when ink is adhered onto the sheet 12, the fibers having hydrophilic properties absorb ink solvent (moisture or organic solvent such as alcohol) of the ink and are swollen, thereby increasing the volume of the recorded area 12a. Moreover, since ink that is not absorbed in the fibers permeates into voids between the fibers of the sheet 12, thereby cutting the hydrogen bonds between the fibers, the fibers of the recorded area 12a are in the state of being movable relative to each other. Therefore, since the recorded area 12a experiences dilation deformation by the squeezing of the swollen fibers, the sheet 12 having the recorded area 12a formed thereon is deformed to be separated from the top surface of the first transport belt 22 with the permeation and diffusion of the ink and thus has such a shape that it ripples along the transport belt 22 (so-called cockling phenomenon).

Next, the sheet 12 having such a rippling occurred therein is conveyed from the first transport belt 22 to the second transport belt 23: that is, it is transported from the first transport zone A to the heating zone B. Then, in the heating zone B, the recorded area 12a of the sheet 12 is heated by the heater 25, whereby evaporation of the ink from the recorded area 12a is accelerated (step of performing the drying operation). Therefore, the recorded area 12a of the sheet 12 is put into a half-dried state by the evaporation of the ink, and at the same time, the ever-increasing volume due to permeation and diffusion of the ink is stopped, so that the dilation level thereof is suppressed.

At this time, the heater 25 heats the sheet 12 in a non-contacting manner with the top surface (that is, a surface on which the ink as the liquid is adhered) of the sheet 12 mounted on the supporting face 23a of the second transport belt 23. Moreover, since the support platens 26 and 27 are not disposed in the heating zone B in the transport path of the sheet 12, the sheet 12 is heated in the heating zone B in a non-restricted state where no negative pressure is applied onto the supporting face 23a of the second transport belt 23 and it is merely mounted thereon. Therefore, wrinkles might not be produced on the sheet 12 because no restricting force in the direction for lowering the dilation level is applied to the recorded area 12a having undergone the dilation deformation.

Subsequently, the sheet 12 is transported to the second transport zone C in a state of being mounted on the supporting face 23a of the second transport belt 23, and is transported to the downstream side in the second transport zone C in a non-heated and non-restricted state. In the present embodiment, the sheet 12 stays in the second transport zone C for one second. Then, the sheet 12 is transported to the restricting zone D after it passes through the second transport zone C.

In the restricting zone D, since the back surface of the second transport belt 23 makes sliding contact with the upper surface 27a of the support platen 27, negative pressure is produced in the air holes 28 disposed in areas of the second transport belt 23 having the sheet 12 mounted thereon and the suction holes 30 of the support platen 27 being communicated with the air holes 28 via the elongated groove-shaped openings. In the present embodiment, in the restricting zone D, the sheet 12 receives negative pressure corresponding to the restricting force (suction force) of 78.4 N/A4 (8 kgf/A4) for only three seconds.

Therefore, the sheet 12 mounted on the second transport belt 23 is absorbed to adhere onto the supporting face 23a of the second transport belt 23 by the negative pressure acting on the back surface thereof and is restricted to be brought into surface-contact with the supporting face 23a which has a smooth surface (step of performing the restricting operation). That is, the sheet 12 is transported to the downstream side with the revolving motion of the second transport belt 23 while being restricted in a planar shape so that the recorded area 12a which is dilated and deformed in the half-dried state maintains a uniform planar state with the surrounding non-recorded area 12b.

Moreover, since the ink is evaporated over time from the recorded area 12a in the course of the transportation thereof, so that the sheet 12 experiences natural seasoning while maintaining the uniform planar state between the recorded area 12a and the non-recorded area 12b, the cockling phenomenon which occurred due to the dilation deformation of the recorded area 12a disappears. Therefore, in the present embodiment, the restricting unit is configured by the second suction portion 32 which produces negative pressure acting on the back surface of the sheet 12 via the air holes 28 of the second transport belt 23 and the suction holes 30 of the support platen 27 with the driving of the fans 33.

It has been found from test results that the disappearance level of the cockling phenomenon differs depending on the amount of the restricting force and restriction period applied to the sheet 12 in each zone and the passing period of the sheet 12 in the course of the transportation of the sheet 12 in which the sheet 12 is transported from the recording zone to the downstream side along the transport path while sequentially passing through the first transport zone A, the heating zone B, the second transport zone C, and the restricting zone D.

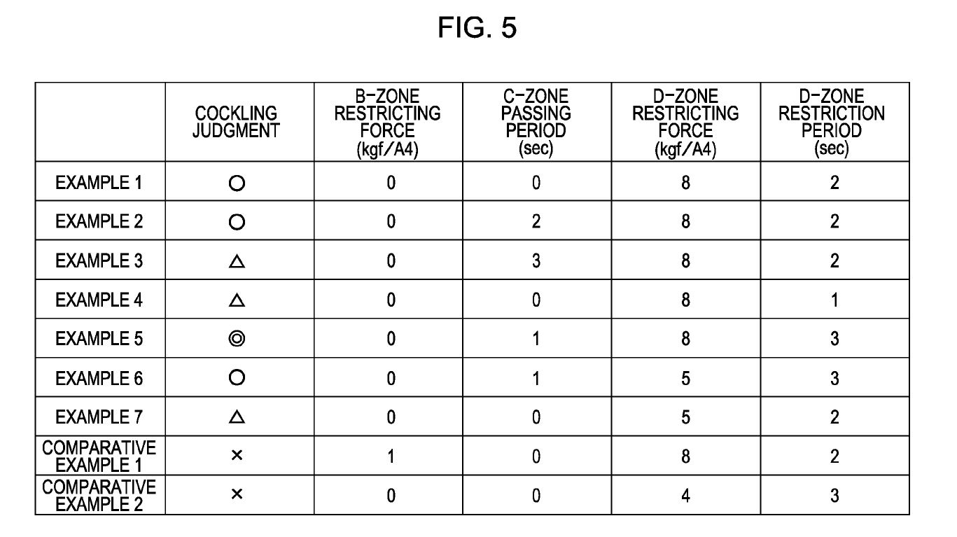

The relationship between the restricting force on the sheet 12 in the heating zone B, the passing period of the sheet 12 in the second transport zone C, and the restricting force and restriction period on the sheet 12 in the restricting zone D, which have particular influence on the disappearance level of the cockling phenomenon, will be described with reference to FIGS. 4 and 5.

FIGS. 4 and 5 show the test results on the restricting force, the restriction period, and the like when ink of 4 mg/inch² (about 0.62 g/cm²) is ejected over a range of area of 25.4×100 mm, of the sheet 12 which is formed of high-quality paper having a density of 104 g/m² (uniform thickness) and has pulps being exposed from the top surface. FIG. 4 is a table which shows the states of the sheet 12 in the restricting zone D under the restricting force and the restriction period for Examples 1 and 4 to 7 and Comparative Example 2 in FIG. 5. In the table, among the symbols of the cockling judgment, which represent the disappearance level of the cockling phenomenon, “ [symbol] ” represents a state where the rippling is completely disappeared, “◯” represents a state where the rippling is almost disappeared, “Δ” represents a state where the rippling is slightly observed, and “x” represents a state where the rippling is clearly observed.

As can be seen from FIG. 4, when the restricting force in the restricting zone D was set to 49 N/A4 (5 kgf/A4) and 78.4 N/A4 (8 kgf/A4) (i.e., 49 N/A4 (5 kgf/A4) or more), the disappearance level of the cockling phenomenon from the recorded area 12a is increased as the restriction period increases. However, when the restricting force was set to 39.2 N/A4 (4 kgf/A4) (i.e., less than 49 N/A4 (5 kgf/A4)) (Comparative Example 2 in FIG. 5), the rippling is maintained regardless of the length of the restriction period. This is thought to be due to a shape retention force for maintaining its shape at that moment, which is greater than the negative pressure (the suction force as the restricting force) of less than 49 N/A4 (5 kgf/4A) applied in the thickness direction of the recorded area 12a of the sheet 12, which has a dilated and deformed shape in the half-dried state.

Next, the relationship between the restricting force on the sheet 12 in the heating zone B and the passing period and the cockling judgment for the sheet 12 in the second transport zone C will be described with reference to FIG. 5. The present embodiment corresponds to Example 5 in FIG. 5.

As illustrated in Comparative Example 1, when a restricting force (9.8 N/A4 (1 kgf/A4)) was applied to the sheet 12 in the heating zone B, the rippling was left and clearly observed, and the disappearance level of the cockling phenomenon was poor. This is thought to be due to the suction force (restricting force) capable of causing twisting of the rippling, which is applied to the sheet 12 being in the state where the rippling caused by the dilation deformation is easily deformed, before the sheet 12 is sufficiently heated by the heater 25. That is, when the magnitude of the restricting force applied to the sheet 12 in the heating zone B is equal to or greater than 9.8 N/A4 (1 kgf/A4), the disappearance level of the cockling phenomenon is poor. Therefore, the case where the sheet 12 is put into the non-restricted state in the heating zone B so that it is able to obtain such a good disappearance level of the cockling phenomenon includes a state where the suction force (the restricting force of less than 9.8 N/A4 (1 kgf/A4) for the sheet 12 and the printing conditions of the present embodiment) which does not cause twisting of the ripping occurred in the sheet 12 at that moment is applied to the sheet 12.

On the other hand, as for the passing period in the second transport zone C, as the period of time required for passing through the zone increases, the ink experiences natural seasoning and the amount of ink remaining in the recorded area 12a decreases. That is, the fibers which are the structural materials of the sheet 12 recombines with each other, whereby the recorded area 12a in the dilated and deformed state is dried with the dilated and deformed shape unchanged. Therefore, as illustrated in Examples 1 to 7, if the passing period in the second transport zone C is within three seconds, the sheet 12 is able to maintain the half-dried state in which an amount of ink sufficiently large enough to deform the recorded area 12a into a planar shape by the restricting force applied in the subsequent restricting zone D is contained therein. That is, if the passing period longer than three seconds is required, the good disappearance level of the cockling phenomenon cannot be obtained.

As for the restricting force in the restricting zone D, as described in FIG. 4, when the restricting force is set to 39.2 N/A4 (4 kgf/A4) similar to Comparative Example 2, because the rippling is maintained, the good disappearance level of the cockling phenomenon cannot be obtained. Moreover, as for the restriction period in the restricting zone D, as described in FIG. 4, as the restriction period increases, the disappearance level of the cockling phenomenon from the recorded area 12a is improved. However, such an extended restriction period has a negative effect on improvement of the overall throughput of the apparatus. On the other hand, if the restriction period for maintaining the recorded area 12a which is dilated and deformed in the half-dried state to be in the planar shape is set to about five seconds, the recorded area 12a maintains such a planar shape even when the restricting force is released after an elapse of the restriction period. Therefore, when the overall throughput of the apparatus is considered, it is desirable to set the restriction period in the restricting zone D to five seconds or less.

In the above-described embodiment, it is possible to obtain the following advantages.

(1) In the heating zone B, since the heater 25 heats the sheet 12, the evaporation of the ink adhered thereon is accelerated, and thus the dilation level of the recorded area 12a of the sheet 12 is suppressed. Moreover, in the restricting zone D, the recorded area 12a in which the evaporation of the ink is accelerated is absorbed to adhere onto the supporting face 23a of the second transport belt 23 in a planar shape. Therefore, the ink on the sheet 12 is evaporated by the natural seasoning while the recorded area 12a maintains its state of being held in the planar shape without producing wrinkles thereon, whereby the recording contents recorded on the recorded area 12a are fixed in the sate where neither rippling nor wrinkles is present. Therefore, it is possible to suppress the rippling or the wrinkles from being left and fixed on the sheet 12.

(2) Since the suction force (restricting force) applied in the restricting zone D is set to be smaller than the suction force applied in the heating zone B, the deformation of the recorded area 12a in which the ink is not sufficiently evaporated is allowed in the heating zone B. Therefore, it is possible to suppress the wrinkles from being left and fixed on the sheet 12.

(3) In the heating zone B, the evaporation of the ink is accelerated in a state where the dilation deformation of the sheet 12 is not impaired. Therefore, the dilated portion of the sheet 12 in which the ink is not yet sufficiently evaporated is prevented from being twisted by the suction force (restricting force), it is possible to suppress production of the wrinkles.

(4) In the heating zone B, the recorded area 12a having undergone the dilation deformation by the ink adhered thereto and absorbed therein is heated in a state in which a restricting force as small as approximately zero, e.g., less than 9.8 N per A4-size page is applied in the heating operation. Therefore, wrinkles which are caused by the unnecessary application of the restricting force are not produced, and it is thus possible to lower the degree of dilation deformation by the accelerated evaporation of the ink.

(5) In the restricting zone D, the suction force (restricting force) capable of forcibly deforming the sheet 12 is applied to the recorded area 12a of the sheet 12 in which the evaporation of the ink is accelerated by the heating in the heating zone B after it underwent the dilation deformation by the ink absorbed therein. Therefore, the recorded area 12a having undergone the dilation deformation can be maintained in the uniform planar state by the suction force.

(6) In the restricting zone D, since the suction force (restricting force) which is sufficiently large and is equal to or greater than 49 N (5 kgf) per A4-size page is applied to the recorded area 12a of the sheet 12, the recorded area 12a having undergone the dilation deformation can be maintained in the uniform planar state even with the sufficiently large restricting force.

(7) Since the suction force (restricting force) is applied to the sheet 12 in the half-dried state where the liquid adhered on the sheet 12 is not yet completely dried, it is possible to deform the target before its dilated and deformed shape is left and fixed thereon.

(8) Since the recorded area 12a in which the dilation level is suppressed because the evaporation of the ink is accelerated by the heating in the heating zone B is restricted for three seconds in the restricting zone D, the recorded area 12a can be restricted to be continuously maintained in the uniform planar state until the movement of the ink in the recorded area 12a is stabilized. Therefore, it is possible to suppress the recorded area 12a from again undergoing the dilation deformation after the restricting force to the sheet 12 is released. Therefore, compared with a case where the sheet 12 is restricted for a long period of time (longer than 5 seconds) until the ink is completely evaporated from the recorded area 12a, it is possible to improve the throughput of the printer 11.

(9) In the second transport zone C, the sheet 12 in which the evaporation of the ink from the recorded area 12a is accelerated by the heating of the heater 25 is transported to the subsequent restricting zone D after an elapse of the passing period as short as one second. Therefore, the sheet 12 can be transported to the restricting zone D before the dilated and deformed shape of the recorded area 12a of the sheet 12 is left and fixed thereon by the natural seasoning after the heating in the heating zone B is ended. Therefore, in the restricting zone D, the restricting force for restricting to the planar shape can be applied, at an appropriate timing, to the recorded area 12a in the half-dried state.

### Second Embodiment

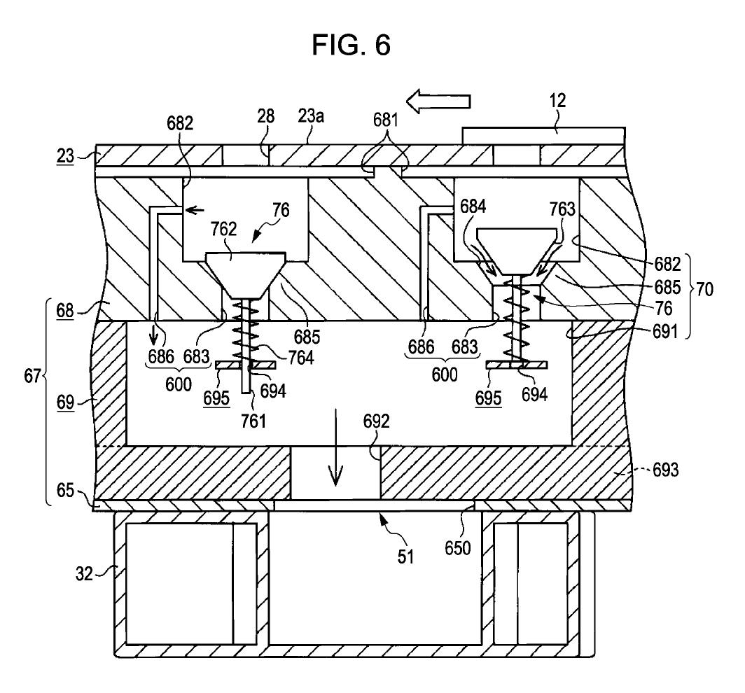

Next, a second embodiment of the invention will be described with reference to FIG. 6. The second embodiment has the same configuration as the first embodiment, except that the shape of the second support platen 27 of the second transport portion 17 is modified. Therefore, the same constituent elements as those of the first embodiment will be referenced by the same reference numerals, and the detailed descriptions thereof will be omitted. The arrows in FIG. 6 represent the flow paths of air when it is sucked by the fan 33 (see FIG. 1). The white arrow represents the transport direction of the sheet 12.

As illustrated in FIG. 6, a second support platen 67 of the present embodiment is provided with a belt support plate 68 that is configured to be capable of supporting the sheet 12 mounted on the second transport belt 23 over the range of the second transport belt 23, a main body 69, and a sealing plate 65. The belt support plate 68, the main body 69 and the sealing plate 65 are stacked in this order from the second transport belt 23 located on the upper side thereof toward the second suction portion 32 located on the lower side thereof.

On the upper surface of the belt support plate 68, similar to the elongated groove-shaped openings of the suction holes 30 of the first embodiment, a plurality of grooves 681 is formed so as to correspond to the rows of the air holes 28 in the transport direction of the sheet 12. The grooves 681 have an elongated shape extending in the transport direction of the sheet 12. The length of each of the grooves 681 in the transport direction of the sheet 12 is set to be approximately equal to the gap between two air holes 28 arranged along the rows thereof in the transport direction of the sheet 12 so that any of the air holes 28 extends over the grooves 681 even when the air holes 28 are moved with the movement of the second transport belt 23.

Moreover, on the bottoms of the grooves 681 of the belt support plate 68, first static pressure cells 682 having an approximately cylindrical shape are recessed. On the other hand, on the bottoms of the first static pressure cells 682, through-holes 683 are formed so as to pass through the lower surface of the belt support plate 68. Furthermore, the opening edge portions located on the upper side of the through-holes 683 and close to the first static pressure cells 682 are chamfered, thereby forming valve seats 685 having abutting surfaces 684 which have a conical surface shape with an enlarged diameter at the upper end thereof.

Moreover, at positions of the lower surface of the belt support plate 68 in the vicinity of the through-holes 683, communication holes 686 as the communication portions which extend upward in parallel to the axial lines of the through-holes 683 and then bend in the horizontal direction to be opened to the inner side faces of the first static pressure cells 682 are formed. The communication holes 686 have a smaller diameter (i.e., smaller flow path sectional size) than the through-holes 683 which are formed with the valve seats 685 at the upper opening edge portions. In the present embodiment, a first flow path portion of the communication flow path 600 is formed by the large-diameter through-holes 683, and a second flow path portion of the communication flow path 600 is formed by the small-diameter communication holes 686.

Further, on the upper surface of the main body 69, a second static pressure cell 691 having an approximately cylindrical shape is recessed so as to extend over two of the first static pressure cells 682 in the transport direction of the sheet 12. Moreover, the two first static pressure cells 682 are communicated with the second static pressure cell 691 via the through-holes 683 and the communication holes 686 having one ends thereof being opened to the respective first static pressure cells 682. The second static pressure cell 691 has a larger volume than the first static pressure cells 682, and a through-hole 692 is formed in the bottom of the second static pressure cell 691 so as to pass through the lower surface of the main body 69. In the main body 69, a plurality of second static pressure cells 691 is formed, and the respective second static pressure cells 691 are communicated with each other via flow paths 693 communicated to the respective through-holes 692.

Further, holes 650 are formed in the sealing plate 65 so as to correspond to suction ports 51 of the second suction portion 32. The suction port 51 is communicated with the flow paths 693 of the main body 69 via the holes 650, whereby the fan 33 (see FIG. 1) is communicated to the respective second static pressure cells 691.

Further, a support plate 695 having a support hole 694 is formed in the second static pressure cell 691 of the main body 69 to be integral with the main body 69 so as to oppose the through-holes 683 of the first static pressure cells 682 located on the upper side thereof. A rod member 761 having a circular column shape, which constitutes a valve 76, is inserted into the support hole 694 so that a lower end thereof is freely slidable. The upper end of the rod member 761 is positioned in the first static pressure cell 682, and a valve body 762 having an approximately truncated conical shape and capable of making surface-contact with the abutting surface 684 of the valve seat 685 is formed to be integral with the upper end of the rod member 761. When a conical abutting surface 763 of the valve body 762 makes abutting contact with the abutting surface 684 of the valve seat 685, the first flow path portion of the communication flow path 600 is closed.

Further, a spring 764 as a biasing member is interposed between the support plate 695 and the valve body 762, so that the valve body 762 of the valve 76 is biased by the biasing force of the spring 764 in the direction for increasing the flow path sectional size of the communication flow path 600. That is, the valve 76 is normally in an open-valve state (first valve state) in which the valve body 762 is separated from the valve seat 685. Here, the biasing force of the spring 764 is smaller than the pressure difference between the first static pressure cell 682 which is not covered by the sheet 12 and in the atmospheric pressure state and the second static pressure cell 691 which is sucked by the fan 33. The biasing force is set to a magnitude capable of separating the valve body 762 from the valve seat 685 when the first static pressure cell 682 and the second static pressure cell 691 are at the same pressure. In the present embodiment, a flow path switching unit 70 for switching between a first state and a second state of the communication flow path 600 is formed by the first static pressure cell 682, the second static pressure cell 691, the valve 76, and the valve seat 685.

Next, the movement of the valve 76 in the flow path switching unit 70 and the first state and the second state of the communication flow path 600 will be described in detail.

Each of the two valves 76 on the left and right sides in FIG. 6 is normally in the open-valve state (first valve state) in which the through-hole 683 as the first flow path portion is opened with the valve body 762 being biased by the biasing force of the spring 764 in the direction of being separated from the valve seat 685. When the fan 33 is driven in such a state, the inside of the second static pressure cell 691 is set to negative pressure by the suction force of the fan 33, and thus the pressure difference between the first static pressure cell 682 which is substantially at the atmospheric pressure and the second static pressure cell 691 exceeds the biasing force of the spring 764. Then, the valve 76 is moved in the direction in which the valve body 762 is seated on the valve seat 685 while resisting against the biasing force of the spring 764, thereby entering a closed-valve state (second valve state) where the through-hole 683 as the first flow path portion is closed (see the left valve 76 in FIG. 6), and the communication flow path 600 enters a second state.

Next, in such a state, when the air holes 28 covered by the sheet 12 among the air holes 28 of the second transport belt 23 transporting the sheet 12 mounted thereon are moved to be located at position corresponding to the first static pressure cell 682 with the movement of the second transport belt 23, air is prevented from being introduced from the outside into the first static pressure cell 682 via the air holes 28. Moreover, a small amount of air is gradually introduced from the first static pressure cell 682 to the second static pressure cell 691 via the communication holes 686 as the second flow path portion. Thus, the pressure difference between the first static pressure cell 682 and the second static pressure cell 691 is gradually decreased to become smaller than the biasing force of the spring 764. Then, the valve 76 is moved in the direction in which the valve body 762 is separated from the valve seat 685 by the biasing force of the spring 764, thereby entering an open-valve state (first valve state) where the through-hole 683 as the first flow path portion is open (see the right valve 76 in FIG. 6), and the communication flow path 600 transitions from the second state to the first state.

That is, when the sheet 12 is transported to pass above the second support platen 67, the suction operation is sequentially performed from the air holes 28 communicated with the first static pressure cell 682. Therefore, in the sheet 12, the front end of the sheet 12, which corresponds to the front side in the transport direction, corresponds to the position at which the suction operation is performed first, and in this case, the front end of the sheet 12 corresponds to the restriction start position. Moreover, as the transportation of the sheet 12 proceeds, the range of areas absorbed to adhere on the supporting face 23a is sequentially extended toward the rear side.

Next, when the air holes 28 not covered by the sheet 12 among the air holes 28 of the second transport belt 23 transporting the sheet 12 mounted thereon are moved from the above-mentioned state to be located at position corresponding to the first static pressure cell 682 with the movement of the second transport belt 23, air is introduced from the outside into the first static pressure cell 682 via the air holes 28. Then, the inside of the first static pressure cell 682 is set to pressure close to the atmospheric pressure, and thus the pressure difference between the first static pressure cell 682 and the second static pressure cell 691 which is set to the negative pressure exceeds the biasing force of the spring 764. Then, the valve 76 is moved in the direction in which the valve body 762 is seated on the valve seat 685 while resisting against the biasing force of the spring 764, thereby entering the closed-valve state (second valve state) where the through-hole 683 as the first flow path portion is closed (see the left valve 76 in FIG. 6), and the communication flow path 600 transitions from the first state to the second state.

In the second embodiment, in addition to the advantages (1) to (9) of the first embodiment, it is possible to obtain the following advantages.

(10) The suction force of the fan 33 is first applied to the front end of the sheet 12 with the transportation of the sheet 12 and is then applied to the rear end side of the sheet 12. Therefore, the range of absorbed areas is gradually extended toward the rear side in the transport direction with the front end of the sheet 12 in the transport direction of the sheet 12 being defined as the restriction start position. Therefore, when the sheet 12 having undergone dilation deformation by the ink absorbed therein is transported, since the front end of the sheet 12 can be first restricted to the supporting face 23a in a smooth manner, it is possible to prevent production of wrinkles due to twisting of the sheet 12.

(11) The volume of each of the first static pressure cell 682 and the second static pressure cell 691 is configured such that the volume of the second static pressure cell 691 as a first negative pressure chamber which is first set to negative pressure with the driving of the fan 33 is larger than the volume of the first static pressure cell 682 as a second negative pressure chamber which is later set to negative pressure. Owing to such a configuration, when the communication flow path 600 transitions from the second state to the first state, a large suction force can be applied to the sheet 12. Therefore, the front end of the sheet 12 in the transport direction can be effectively absorbed.

(12) The valve 76 in the closed-valve state is opened when the sheet 12 is transported thereto, and is closed when the sheet 12 passes therethrough. Therefore, since only the valve which is located at position corresponding to the sheet 12 is opened, the suction force of the fan 33 can be concentrated on the sheet 12, thereby increasing the suction efficiency.

The above-described embodiments may be modified in the following manner.

In the second embodiment, a mechanism (e.g., cam mechanism or solenoid) for displacing the valve body 762 may be further provided, and the restriction start position is not limited to the front end in the transport direction of the sheet 12 or may be the four corners and end portions or the central portion of the sheet 12. That is, for example, when the rear end in the transport direction of the sheet is used as the restriction start position, the restricting range can be extended by opening the valve 76 toward the front side in the transport direction at a speed faster than the transport speed. Moreover, the skewing of the restricting force applied to the sheet 12 can be reduced by absorbing the sheet 12 so that the restricting range is gradually extended from the restriction start position.

In the respective embodiments, the restriction period in which the sheet 12 is restricted in the restricting zone D may be set to a period other than three seconds. For example, a restriction period ranging from one to five seconds other than three seconds can contribute to improvement of the throughput. Moreover, in this case, the restriction period may be five seconds or more. In such a case, the increase in size of the printer 11 can be suppressed by slowing down the transport speed of the sheet 12 in the restricting zone D. Moreover, in this case, the restriction period may be less than one second. In such a case, the planarity can be improved even with the restriction period of less than one second by increasing the restricting force to the sheet 12 in the restricting zone D.

In the respective embodiments, rather than transporting the sheet 12 along the transport path, the recording head 24 and the heater 25 may be moved in a state where the sheet 12 is fixed at its position, thereby performing printing and drying on the sheet 12.

In the respective embodiments, as long as the suction force (restricting force) applied to the sheet 12 in the heating zone B has a magnitude (restricting force of less than 9.8 N/A4 (1 kgf/A4) for the sheet 12 and the printing conditions of the embodiment) which does not cause twisting of the rippling occurred in the sheet 12 at that moment, the sheet 12 may be heated in a state where the suction force is applied thereto.

In the respective embodiments, the passing period during which the sheet 12 is transported in the second transport zone C may be set to a period other than one second if it is within three seconds. Alternatively, the second transport zone C may be omitted so that the sheet 12 is transported directly from the heating zone B to the restricting zone D.

In the respective embodiments, the restricting force applied to the sheet 12 in the restricting zone D is not limited to 78.4 kgf/A4 (8 kgf/A4) as long as it is equal to or greater than 49 N/A4 (5 kgf/A4).

In the respective embodiments, the heating zone B may be set to be positioned between the first transport belt 22 and the second transport belt 23, and a fixing member having an upper surface thereof being even with sheet-mounted surfaces (supporting faces) of both transport belts 22 and 23 may be provided at a position located between both transport belts 22 and 23. Alternatively, a transport roller without the suction unit may be provided.

In the respective embodiments, a lengthy continuous sheet rolled around a rolling shaft in a roll-like form may be used as the target. In this case, the transport unit rotates the rolling shaft to continuously transport the continuous sheet as the target from the upstream side to the downstream side, and the thus-transported continuous sheet is restricted to a planar state by being supported on the upper surfaces (supporting faces) of the support platens 27 and 67 functioning as the support member in a slidably contacting state.

In the respective embodiments, rather than ejecting ink from the recording head 24, the ink may be adhered on the top surface of the target by other printing methods such as porous printing or the like.

In the respective embodiments, the sheet 12 transported to the restricting zone D may be pressed onto the supporting face using a roller or a plate directly pressing the recorded area 12a because the evaporation of the ink is accelerated in the heating zone B. When the roller is used, since the range of areas to be restricted to the supporting face in the sheet 12 in which the degree of deformation is suppressed in the heating zone B can be gradually changed, the sheet 12 can be restricted in a loose manner, thereby suppressing the production of wrinkles. Moreover, an additional support platen having a drying unit may be provided so that the lower surface of the sheet 12 being transported by the transport belts 22 and 23 is heated.

In the respective embodiments, the drying unit may be provided with an air blower so that air (warm air) is blown from the upper side of the sheet 12. By doing so, it is possible to accelerate drying of ink having low absorption efficiency to radiation heat. More preferably, the air blowing treatment may be performed after the sheet is heated by the heater 25. In this way, when printing (color printing) is performed using a plurality of kinds of ink (e.g., color ink) by using a radiant heater 25, it is possible to suppress generation of heating marks even when the absorption efficiency of the ink to radiation heat is different due to the influence of the colors of the ink, the moisture content, or the like. Further, by preliminarily accelerating the drying using the radiant heater 25, it is possible to suppress the air-induced movement of the ink.

In the respective embodiments, the upper surfaces 27a of the support platens 27 and 67 restricting the sheet 12 in the restricting zone D may have a cylindrical surface shape. Even in such a case, the recorded area 12a of the sheet 12 can be restricted to be in the uniform planar state with the non-recorded area 12b.

In the respective embodiments, as the constituent material of the target, cellulose-based samples which have hydrophilic properties and thus have a swelling effect by absorbing water may be used. Examples of such cellulose-based samples include cotton, hemp, polynosic, and lyocell. Moreover, such a target may be deformed by causing liquid made of polar solvent (e.g., ethanol) to be adhered onto the target.

Next, the technical ideas that can be grasped from the above-described embodiment and modifications will be additionally described below.

(1) The recording apparatus according to any one of the above-described aspect and the embodiments, wherein the restricting unit produces negative pressure acting on a surface of the target opposite to the surface having the ink adhered thereon, thereby restricting the target so that the surface opposite to the surface having the liquid adhered thereon is brought into surface-contact with the supporting face of the support member capable of supporting the target.

According to such a configuration, for example, even when the perimeter of the liquid adhered area of the target is surrounded by the non-liquid adhered area on which no liquid is adhered, the restricting force for maintaining the island-shaped liquid adhered area having undergone the dilation deformation to be in a uniform planar state with the surrounding non-liquid adhered area is applied to the target in a non-contacting manner with the liquid adhered area by the action of the negative pressure. Therefore, the restricting force can be efficiently applied without causing deterioration in the recording quality.

(2) The recording apparatus according to any one of the above-described aspect and the embodiments, wherein the restricting unit includes a flow path switching unit capable of switching between a first state and a second state of a plurality of communication flow paths, which is formed in the support member so as to transmit negative pressure to the target, the second state having a smaller flow path sectional size than the first state and being a state where the communication flow paths are not closed.

According to such a configuration, since the flow path switching unit switches between the first state and the second state of the communication flow paths, the negative pressure can be selectively produced in the plurality of communication flow paths. Therefore, since the restricting force to the target can be changed in a simple manner, it is possible to easily change a restricting method to comply with the kind of targets, e.g., high-quality paper or Japanese paper.

(3) The recording apparatus according to any one of the above-described aspect and the embodiments, further including a transport unit for transporting the target, wherein in the course of transportation of the target by the transport unit, the flow path switching unit switches the communication flow paths to the first state in synchronism with a timing at which a front end of the target passes therethrough and switches the communication flow paths to the second state in synchronism with a timing at which a rear end of the target passes therethrough.

According to such a configuration, by switching the states of the communication flow paths in synchronism with the transportation timings of the target, it is possible to suppress the communication flow paths on which the target is not mounted from performing the suction operation. Therefore, the restricting force can be concentrated on the target, thereby improving the restricting efficiency of the target. Moreover, since the front end and the rear end of the target are also sucked toward the supporting face similar to the central portion of the target, the target can be stably transported in a state where the floating of the target is suppressed. Furthermore, by performing the restricting operation in synchronism with the transportation of the target, it is possible to miniaturize the restricting unit for obtaining the restriction period required for planarizing the ripping of the target which is swelled by absorbing the adhered liquid, thereby contributing to miniaturization of the recording apparatus.

(4) The recording apparatus according to any one of the above-described aspect and the embodiments, further comprising a transport unit for transporting the target, wherein a recording zone in which the recording unit performs the recording operation on the target, a drying zone in which the drying unit performs the drying operation on the target at a position located on the downstream side of the recording zone, and a restricting zone in which the restricting unit restricts the target at a position located on the downstream side of the drying zone are arranged along a transport path of the target by the transport unit.

According to such a configuration, when the target sequentially passes through the recording zone in which the recording operation is performed on the target, the drying zone in which the drying operation is performed on the target, and the restricting zone in which the target is restricted, along the transport path, the recording operation can be effectively performed during a series of assembly-line operations.

What is claimed is:

1. A recording apparatus comprising:
a recording unit that performs a recording operation on a target by causing liquid to adhere onto the target;
a drying unit that performs a drying operation on the target on which the liquid is adhered by the recording operation of the recording unit in a state where a restricting force is not substantially applied thereto; and
a restricting unit that performs a restricting operation on the target which has been subjected to the drying operation by the drying unit while supporting the target on a supporting face of a support member capable of supporting a top surface of the target having the liquid adhered thereon in a uniform planar state, the restricting operation applying a restricting force to the target, the restricting force being directed toward the supporting face.

2. The recording apparatus according to claim 1, wherein the restricting force which is applied to the target in the drying operation is smaller than the restricting force which is applied to the target in the restricting operation.

3. The recording apparatus according to claim 1, wherein the restricting force which is applied to the target in the drying operation is controlled so as not to cause forced deformation of the target having the liquid adhered thereon.

4. The recording apparatus according to claim 1, wherein the restricting force which is applied to the target in the drying operation is less than 9.8 N per A4-size page.

5. The recording apparatus according to claim 1, wherein the restricting force which is applied to the target in the restricting operation is controlled so as to cause forced deformation of the target having the liquid adhered thereon.

6. The recording apparatus according to claim 1, wherein the restricting force which is applied to the target in the restricting operation is equal to or greater than 49 N per A4-size page.

7. The recording apparatus according to claim 1, wherein the restricting unit performs the restricting operation on the target which is half dried by the drying operation.

8. The recording apparatus according to claim 1, wherein the restricting unit performs the restricting operation on the target within three seconds after the drying unit performs the drying operation on the target.

9. The recording apparatus according to claim 1, wherein the restricting unit applies the restricting force to the target in the restricting operation for a period of one to five seconds.

10. The recording apparatus according to claim 1, wherein the restricting unit applies the restricting force to the target in such a manner that based on a restriction start position at which the restricting force is first applied to the target, a restricting force application range is sequentially extended from the restriction start position.

11. A recording method, comprising the steps of:
performing a recording operation on a target by causing liquid to adhere onto the target;
performing a drying operation on the target which has been subjected to the recording operation in a state where a restricting force is not substantially applied thereto; and
performing a restricting operation on the target which has been subjected to the drying operation, the restricting operation restricting the target with a restricting force capable of restricting a surface of the target having the liquid adhered thereon in a uniform planar state.
